(19) United States
(12) Patent Application Publication
(10) Pub. No.: US 2020/0149490 A1
(43) Pub. Date: May 14, 2020

(54) VEHICLE SYSTEM AND A METHOD OF INCREASING EFFICIENCY OF AN ENGINE

(71) Applicant: GM Global Technology Operations LLC, Detroit, MI (US)

(72) Inventors: Martino A. Casetti, Clarkston, MI (US); Michael J. Lucido, Northville, MI (US); Ping Ge, Northville Twp, MI (US); Jennifer C. Wheeler, Milford, MI (US)

(73) Assignee: GM Global Technology Operations LLC, Detroit, MI (US)

(21) Appl. No.: 16/184,402

(22) Filed: Nov. 8, 2018

(51) Int. Cl. F02D 41/14; F02M 26/16; F02M 26/46; F02D 41/38; F02M 26/22; F02B 29/04; F02M 26/19; F02M 26/05

(52) U.S. Cl. CPC F02D 41/1439; F02M 26/16; F02M 26/46; F02D 41/38; F02M 26/22; F02D 2041/147; F02M 26/19; F02D 41/1444; F02M 26/05; F02D 2041/389; F02B 29/04

(57) ABSTRACT

A vehicle system includes an engine defining a plurality of cylinders and configured to combust a fuel. A method of increasing efficiency of an engine includes controlling an amount of fuel being injected into the plurality of cylinders of the engine via a respective fuel injector. An exhaust gas recirculation (EGR) system is in selective fluid communication with a second subset of the plurality of cylinders and the air intake system to route the second exhaust product from the second subset of the plurality of cylinders to an air intake system. A valve is coupled to the EGR system and the exhaust system. A first sensor is disposed between the valve and the air intake system, and measures an amount of reformate in the second exhaust product when the valve is in a second position.

### INTRODUCTION

Internal combustion engines (ICE) combust a mixture of air and fuel within one or more combustion chambers to produce a mechanical output. During the combustion, various exhaust gases are produced. In some instances, a portion of the exhaust gas may be recirculated back into the engine cylinders (via an exhaust gas recirculation (EGR) system). In a gasoline engine, this inert exhaust may displace an amount of fresh air of a combustible mixture in the cylinder resulting in increased engine efficiency. The recirculated exhaust gas or EGR may reduce the combustion temperature in the cylinder which reduces heat transfer losses and/or may reduce the creation of certain gaseous byproducts. Displacement of fresh air may reduce pumping losses.

During start-up or initial warm-up of the ICE, recirculation of the portion of the exhaust gas back to the engine cylinders may not be desired, and therefore, a valve may divert this exhaust gas out through an aftertreatment device. Once the ICE is warmed up, the three-way valve may divert the portion of the exhaust gas back to the engine to recirculate this exhaust gas into the engine cylinders.

Internal combustion engines are often called upon to generate considerable levels of power for prolonged periods of time on a dependable basis. Many such ICE assemblies employ a supercharging device, such as an exhaust gas turbine driven turbocharger, to compress the airflow before it enters the intake manifold of the engine in order to increase power and efficiency. Specifically, a turbocharger is a centrifugal gas compressor that forces more air and, thus, more oxygen into the combustion chambers of the ICE than is otherwise achievable with ambient atmospheric pressure. The additional mass of oxygen-containing air that is forced into the ICE improves the engine's volumetric efficiency, allowing it to burn more fuel in a given cycle, and thereby produce more power. Generally, the turbocharger is disposed upstream from the aftertreatment device.

A typical turbocharger includes a central shaft that is supported by one or more bearings and that transmits rotational motion between an exhaust-driven turbine wheel and an air compressor wheel. Both the turbine and compressor wheels are fixed to the shaft, which in combination with various bearing components constitute the turbocharger's rotating assembly.

### SUMMARY

The present disclosure provides a vehicle system including an engine defining a plurality of cylinders and configured to combust a fuel. The vehicle system also includes an air intake system disposed upstream from the engine, and each of the cylinders is coupled to the air intake system. Combustion of the fuel occurs within a first subset of the plurality of cylinders which produces a first exhaust product. Combustion of the fuel also occurs within a second subset of the plurality of cylinders which produces a second exhaust product. The vehicle system further includes an exhaust system disposed downstream from the engine. The exhaust system is in fluid communication with the first subset of the plurality of cylinders. The vehicle system also includes an exhaust gas recirculation (EGR) system in selective fluid communication with the second subset of the plurality of cylinders and the air intake system to route the second exhaust product from the second subset of the plurality of cylinders to the air intake system. Additionally, the vehicle system includes a valve coupled to the EGR system and the exhaust system. The valve includes a first position that routes the second exhaust product directly to the exhaust system and bypasses the EGR system, and the valve includes a second position that routes the second exhaust product directly to the EGR system. The EGR system includes a first sensor disposed between the valve and the air intake system. The first sensor measures an amount of reformate in the second exhaust product when the valve is in the second position.

The vehicle system optionally includes one or more of the following:

A) each of the cylinders include a fuel injector configured to introduce the fuel into the respective cylinders for combustion;

B) a controller in electrical communication with the first sensor and the respective fuel injector in which the controller signals the respective fuel injector to adjust the amount of the fuel being introduced into the respective cylinders depending on the amount of reformate in the second exhaust product when the valve is in the second position;

C) the first sensor measures an amount of air and fuel in the second exhaust product when the valve is in the second position;

D) the controller in electrical communication with the first sensor and the respective fuel injector in which the controller signals the respective fuel injector to adjust the amount of the fuel being introduced into the respective cylinders depending on the amount of reformate, air and fuel in the second exhaust product when the valve is in the second position;

E) extra fuel is added to the second subset of the plurality of cylinders during combustion via the respective fuel injector to increase the amount of reformate disposed in the second exhaust product to restore combustion stability when the second exhaust product reaches the cylinders after being routed through the EGR system;

F) the EGR system includes an EGR cooler disposed between the first sensor and the air intake system, and the EGR cooler is configured to output the second exhaust product at a predetermined temperature which reduces combustion temperature at the cylinders;

G) extra fuel is added to the second subset of the plurality of cylinders via the respective fuel injector to increase the amount of reformate that is routed through the EGR system to stabilize combustion at the cylinders;

H) the air intake system includes an air cooler configured to output fresh air at a predetermined temperature;

I) the predetermined temperature of the fresh air and the second exhaust product reduces a combustion temperature at the cylinders;

J) the air intake system includes an EGR mixer that is configured to mix the fresh air from the air cooler and the second exhaust product when the valve is in the second position to direct the fresh air and the second exhaust product which includes a predetermined amount of reformate at the predetermined temperature to each of the cylinders;

K) the EGR cooler is disposed between the first sensor and the EGR mixer, and extra fuel is added to the second subset of the plurality of cylinders via the respective fuel injector to increase the amount of reformate that is routed through the EGR system to stabilize combustion at the cylinders;

L) a turbocharger in fluid communication with the exhaust system, and wherein the turbocharger expels the first exhaust product, and expels the second exhaust product when the valve is in the first position which bypasses the EGR system;

M) an aftertreatment apparatus coupled to the turbocharger, and configured to remove byproduct of the exhaust product prior to exiting the exhaust system;

N) a second sensor disposed between the turbocharger and the aftertreatment apparatus to measure an amount of the byproduct that enters the aftertreatment apparatus;

O) the controller in electrical communication with the first sensor to compile information regarding the amount of reformate in the second exhaust product when the valve is in the second position, and the controller is in electrical communication with the second sensor to compile information regarding the amount of byproduct;

P) the air intake system is disposed upstream from the engine;

Q) the EGR mixer is disposed upstream from the engine;

R) the EGR cooler is disposed between the first sensor and the EGR mixer;

S) wherein the first sensor is disposed between the EGR cooler and the valve; and

T) the controller is in electrical communication with the respective fuel injector in which the controller signals the respective fuel injector to adjust the amount of the fuel being introduced into the respective cylinders depending on the information collected via the first sensor regarding the amount of reformate detected in the second exhaust product when the valve is in the second position.

The present disclosure also provides a method of increasing efficiency of an engine. The method includes controlling an amount of fuel being injected into a plurality of cylinders of the engine via a respective fuel injector. The method also includes combusting the fuel in a first subset of the plurality of cylinders to produce a first exhaust product, and combusting extra fuel in a second subset of the plurality of cylinders to produce a second exhaust product having an additional amount of reformate. The method further includes expelling the first exhaust product out of the first subset of the plurality of cylinders and through an exhaust system, and expelling the second exhaust product out of the second subset of the plurality of cylinders and through an exhaust gas recirculation (EGR) system when a valve is in a predetermined position. Additionally, the method includes measuring the amount of reformate in the second exhaust product via a first sensor when the second exhaust product is directed through the EGR system, and determining whether to adjust the amount of fuel being injected into the cylinders via the respective fuel injector due to the measured amount of reformate.

The method optionally includes one or more of the following:

A) cooling the second exhaust product via an EGR cooler of the EGR system to output the second exhaust product at a predetermined temperature, and wherein the EGR cooler is disposed downstream from the first sensor;

B) outputting fresh air from an air cooler of an air intake system at a predetermined temperature;

C) mixing the fresh air from the air cooler and the second exhaust product via an EGR mixer when the second exhaust product is directed through the EGR system to direct the fresh air and the second exhaust product which includes a predetermined amount of reformate at the predetermined temperature to each of the cylinders;

D) reducing a combustion temperature at the cylinders due to the predetermined temperature of the fresh air and the second exhaust product directed to the cylinders;

E) adding extra fuel to the second subset of the plurality of cylinders via the respective fuel injector to increase the amount of reformate that is routed through the EGR system to stabilize combustion at the cylinders;

F) determining whether to adjust the amount of fuel being injected into the cylinders via the respective fuel injector due to the measured amount of reformate includes compiling information via a controller regarding the measured amount of reformate in the second exhaust product detected via the first sensor; and

G) controlling the amount of fuel being injected into the cylinders includes signaling the respective fuel injector, via the controller, to adjust the amount of the fuel being introduced into the respective cylinders depending on the compiled information via the controller regarding the measured amount of reformate detected in the second exhaust product expelled through the EGR system.

The detailed description and the drawings or FIGS. are supportive and descriptive of the disclosure, but the claim scope of the disclosure is defined solely by the claims. While some of the best modes and other configurations for carrying out the claims have been described in detail, various alternative designs and configurations exist for practicing the disclosure defined in the appended claims.

### BRIEF DESCRIPTION OF THE DRAWINGS

FIG. 1 is a schematic diagram of a vehicle system including an engine with an exhaust gas recirculation system.

### DETAILED DESCRIPTION

Those having ordinary skill in the art will recognize that all directional references (e.g., above, below, upward, up, downward, down, top, bottom, left, right, vertical, horizontal, etc.) are used descriptively for the FIGS. to aid the reader's understanding, and do not represent limitations (for example, to the position, orientation, or use, etc.) on the scope of the disclosure, as defined by the appended claims.

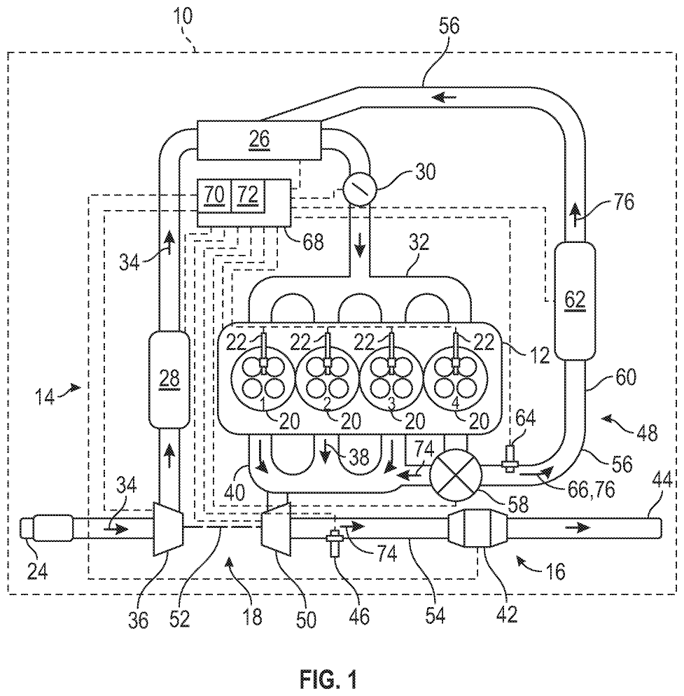

Referring to the FIGURE, wherein like numerals indicate like or corresponding parts throughout the several views, FIG. 1 schematically illustrates a vehicle system 10 of a motor vehicle including an engine 12, an air intake system 14, and an exhaust system 16. The air intake system 14 and the exhaust system 16 may each respectively be in fluid communication with the engine 12, and may be in mechanical communication with each other through a turbocharger 18.

The engine 12 may be an internal combustion engine, such as a spark-ignited internal combustion engine or any other suitable internal combustion engine. The engine 12 may define a plurality of cylinders 20 (also referenced as cylinders 1-4). Generally, the engine 12 is configured to combust a fuel. Each of the cylinders 20 include a fuel injector 22 configured to introduce the fuel into the respective cylinders 20 for combustion. For example, each of the respective cylinders 20 may include one or more fuel injectors 22 that may selectively introduce liquid fuel (as an aerosol) into each cylinder 20 for combustion. In FIG. 1, each of the plurality of cylinders 20 includes one fuel injector 22.

Each of the plurality of cylinders 20 may be in selective fluid communication with the air intake system 14 to receive fresh/oxygenated air, and each of the plurality of cylinders 20 may be in selective fluid communication with the exhaust system 16 to, for example, expel the byproducts of combustion. While the illustrated engine 12 depicts a 4-cylinder engine, the present technology is equally applicable to inline three, six cylinder engines, whether inline or otherwise configured, and V-8, V-10, and V-12 configuration engines, among others.

In certain configurations, each of the plurality of cylinders 20 is coupled to the air intake system 14. The air intake system 14 may generally include, one or more of, a fresh-air inlet 24, an exhaust gas recirculation (EGR) mixer 26, an air cooler 28 or a charge air cooler 28, a throttle 30, and an intake manifold 32. As may be appreciated during operation of the engine 12, fresh air 34 or intake air may be ingested by the air intake system 14 from the atmosphere (or from an associated air-cleaner assembly) via the fresh-air inlet 24. Therefore, the air intake system 14 is disposed upstream from the engine 12. Upstream being relative to the direction of the fresh air 34 entering the fresh-air inlet 24. The throttle 30 may include a controllable baffle configured to selectively regulate the total flow of air through the air intake system 14, and ultimately into the cylinders 20 (via the intake manifold 32).

As generally shown in FIG. 1, the air cooler 28 may be disposed upstream from the EGR mixer 26 and the throttle 30. For example, the air cooler 28 may be disposed between the fresh-air inlet 24 and the EGR mixer 26. In general, the air cooler 28 may be a radiator-style heat exchanger that may use a flow of atmospheric air or liquid coolant to cool the fresh air 34. As such, the air cooler 28 may be configured to output fresh air 34 at a predetermined temperature.

As may be appreciated, the gas mixture may be warmer than atmospheric temperature due to the pressurization via a compressor 36 of the turbocharger 18. The compressor 36 of the turbocharger 18 is disposed upstream from the air cooler 28. Again, upstream being relative to the direction of the fresh air 34 entering the fresh-air inlet 24. More specifically, the air cooler 28 may be disposed between the compressor 36 and the EGR mixer 26. As such, the air cooler 28 may cool the fresh air 34 outputted from the compressor 36 to the desired predetermined temperature. The air cooler 28 may cool the gas mixture to increase its density/volumetric efficiency, while also reducing the potential for abnormal combustion.

The air cooler 28 may include a plurality of closed cooling passageways that fluidly couple an inlet 24 volume with an outlet volume. The cooling passageways may be formed from a thermally conductive material, such as aluminum, and may further include a plurality of heat transfer features, such as fins or wires, that may promote heat transfer between the externally flowing atmospheric air or liquid coolant and the internally contained gas mixture.

The exhaust system 16 is disposed downstream from the engine 12. Downstream being relative to the direction of the arrow 38 in FIG. 1. Therefore, the exhaust system 16 may include an exhaust manifold 40 that generally guides flowing exhaust gas away from the engine 12. Combustion of the fuel occurs within a first subset of the plurality of cylinders 20 which produces a first exhaust product. For example, the first subset of the plurality of cylinders 20 may be, as referenced in FIG. 1, cylinders 1-3, and the first exhaust product may be exhaust gas, which is discussed further below. The exhaust system 16 is in fluid communication with the first subset of the plurality of cylinders 20. Therefore, the first exhaust product may be expelled through the exhaust system 16. Specifically, the first exhaust product may be guided through the exhaust manifold 40 away from the engine 12. In certain configurations, optionally, the exhaust flow from the cylinders 20 may be divided into different flows, which may be separately routed to the turbocharger 18 via multiple exhaust manifolds 40.

Combustion of the fuel also occurs within a second subset of the plurality of cylinders 20 which produces a second exhaust product. For example, the second subset of the plurality of cylinders 20 may be, as referenced in FIG. 1, cylinder 4, and the second exhaust product may be exhaust gas, which is discussed further below. The first and second exhaust product may be different. For example, the second exhaust product may be a richer mixture than the first exhaust product. In other words, more fuel may be injected into the second subset of the plurality of cylinders 20 than the first subset of the plurality of cylinders 20, which causes the second exhaust product to be richer. Simply stated, different amounts of fuel being combusted in the cylinders 20 produce different exhaust gases, which the vehicle system 10 may use to optimize efficiency of the engine 12.

An aftertreatment apparatus 42 may be coupled to the turbocharger 18, and is configured to remove byproduct of the exhaust product prior to exiting the exhaust system 16. Generally, the exhaust gas may eventually pass through the aftertreatment apparatus 42 to catalyze and/or remove certain byproducts prior to exiting the exhaust system 16 via a tailpipe 44. The aftertreatment apparatus 42 may include a catalyst, a three-way catalyst or any other suitable components/catalysts, etc., to catalyze and/or remove various byproducts prior to exiting the exhaust system 16.

A sensor 46, referred to herein as a second sensor 46, may be disposed between the turbocharger 18 and the aftertreatment apparatus 42 to measure an amount of the byproduct that enters the aftertreatment apparatus 42. Information from the second sensor 46 may be utilized to adjust an amount of fuel injected into the cylinders 20 to minimize the amount of byproduct in the exhaust gas that ultimately exits the tailpipe 44. The second sensor 46 may be an air-fuel sensor, a wide range oxygen sensor, a hydrocarbon sensor, or any other suitable sensor to measure the byproducts of the first exhaust product. Other optional examples of the second sensor 46 may include a catalytic sensor, an electrochemical sensor, a metal oxide sensor, a MOSFET sensor, etc.

The air intake system 14 and the exhaust system 16 may be in mechanical communication through the turbocharger 18. Generally, the turbocharger 18 is in fluid communication with the exhaust system 16, and the turbocharger 18 expels the first exhaust product. The turbocharger 18 also expels the second exhaust product in certain situations which bypasses an EGR system 48, which will be discussed further below.

The turbocharger 18 may include a turbine 50 in fluid communication with the exhaust system 16 and the compressor 36 in fluid communication with the air intake system 14. The turbine 50 and the compressor 36 may be mechanically coupled via a rotatable shaft 52. The turbocharger 18 may utilize the energy of the first exhaust product flowing from the engine 12 to spin the turbine 50 and the compressor 36. The rotation of the compressor 36 may then draw fresh air 34 in from the inlet 24 and compress the air into the remainder of the air intake system 14. The first exhaust product is expelled through the turbocharger 18. Once the first exhaust product is expelled from the turbocharger 18, the first exhaust product flows toward the aftertreatment apparatus 42.

A first conduit 54 is disposed between the turbocharger 18 and the aftertreatment apparatus 42 to guide the first exhaust product toward the aftertreatment apparatus 42. More specifically, the first conduit 54 is coupled to the turbine 50 of the turbocharger 18 and the aftertreatment apparatus 42.

The vehicle system 10 may further include the EGR system 48 that may selectively route, via an EGR manifold 56, the second exhaust product from one or more of the cylinders 20 of the engine 12 back into the air intake system 14. Specifically, the EGR system 48 is in selective fluid communication with the second subset of the plurality of cylinders 20 and the air intake system 14 to route the second exhaust product from the second subset of the plurality of cylinders 20 to the air intake system 14. This recirculated second exhaust product, such as exhaust gas, may mix with the fresh air 34 at the EGR mixer 26, and may correspondingly dilute the oxygen content of the mixture. The use of the EGR system 48 may increase efficiency, such as fuel efficiency, in spark ignition engines 12. Furthermore, the EGR system 48 may reduce a combustion temperature and NOx production from the engine 12. Using a separate EGR manifold 56 to route the second exhaust product from one or more cylinders 20 back to the air intake system 14 may be referred to herein as an “enhanced EGR.”

With continued reference to FIG. 1, one of the cylinders 20 (such as cylinder 4) is an EGR cylinder 20 that may selectively supply all of the second exhaust product back to the air intake system 14. As mentioned above, the first exhaust product of the remaining three cylinders 20 (such as cylinders 1-3) is expelled from the engine 12 via the exhaust system 16 through the aftertreatment apparatus 42.

For example, during start-up or initial warm-up of the engine 12, it is desirable to route the second exhaust product away from the engine 12. In other words, the second exhaust product bypasses the EGR system 48 and is expelled through the aftertreatment apparatus 42. A valve 58 is coupled to the EGR system 48 and the exhaust system 16. The valve 58 may be utilized to selectively route the second exhaust product through the EGR system 48. Additionally, the valve 58 may selectively route the second exhaust product away from the EGR system 48 during warm-up of the engine 12. Once the desired temperature is reached, for example in the engine 12 or the aftertreatment apparatus 42, the valve 58 may then route the second exhaust product through the EGR system 48. Specifically, the valve 58 may be coupled to the EGR system 48 to selectively route the second exhaust product to the exhaust system 16 to bypass the EGR system 48, or route the second exhaust product through the EGR system 48 back to the air intake system 14. It is to be appreciated that the valve 58 may be any suitable type of valve 58, and examples of suitable valves 58 are a three-way valve 58 or a bypass valve 58.

Generally, the valve 58 is disposed between the second subset of the plurality of cylinders 20, which in FIG. 1 is cylinder 4, and the EGR system 48. Specifically, the valve 58 may be coupled to the exhaust manifold 40. The valve 58 is coupled to the EGR system 48 to selectively route the second exhaust product through the EGR manifold 56, and is coupled to the exhaust system 16 to selectively route the second exhaust product to the exhaust system 16 while bypassing the EGR system.

The valve 58 may be actuated to change the direction of flow of the second exhaust product. The valve 58 includes a first position that routes the second exhaust product directly to the exhaust system 16 and bypasses the EGR system 48. Therefore, the valve 58 may be in fluid communication with the turbine 50 of the turbocharger 18 through the exhaust manifold 40 when the valve 58 is in the first position. The valve 58 also includes a second position that routes the second exhaust product directly to the EGR system 48 (and back to the air intake system 14). The valve 58 may be actuated to the first and second positions. Therefore, the second subset of the plurality of cylinders 20 (such as cylinder 4 in FIG. 1) is an EGR cylinder 20, and when the valve 58 is in the second position, all of the second exhaust product is routed back to the air intake system 14, and when the valve 58 is in the first position, all of the second exhaust product is routed through the turbocharger 18 and into the aftertreatment apparatus 42. The turbocharger 18 expels the second exhaust product when the valve 58 is in the first position which bypasses the EGR system 48.

A second conduit 60 may be coupled to the valve 58 and the EGR cooler 62 to guide the second exhaust product into the EGR system 48 when the valve 58 is in the second position. Therefore, the valve 58 is disposed between the second conduit 60 and the second subset of the plurality of cylinders 20. As such, the valve 58 is in fluid communication with the EGR system 48 when the valve 58 is in the second position.

Generally, the EGR mixer 26 may be disposed upstream from the engine 12. The EGR mixer 26 is configured to mix the fresh air 34 from the air cooler 28 and the second exhaust product when the valve 58 is in the second position to output the fresh air 34 and the second exhaust product which includes a predetermined amount of reformate to each of the cylinders 20. More specifically, the EGR mixer 26 is configured to mix the fresh air 34 from the air cooler 28 and the second exhaust product when the valve 58 is in the second position to direct the fresh air 34 and the second exhaust product which includes the predetermined amount of reformate at the predetermined temperature to each of the cylinders 20. The amount of reformate, and specifically for example the amount of hydrogen, directed to each of the cylinders 20 stabilizes combustion, which would otherwise deteriorate due to a high percentage of the second exhaust product recirculated (such as about 20-30% of exhaust gas recirculated, or about 25% of the exhaust gas recirculated) in the air/fuel (gas) mixture being combusted.

The exhaust gas that exits the cylinders 20 is generally at a higher temperature than the temperature of the gas mixture entering the air intake system 14 due to the combustion process. Therefore, the EGR system 48 may include an EGR cooler 62. The EGR cooler 62 may decrease the temperature of the second exhaust product as compared to the temperature of the second exhaust product that immediately exits the second subset of the plurality of cylinders 20. Therefore, the EGR cooler 62 may cool the gas mixture to increase its density/volumetric efficiency, while also reducing the potential for abnormal combustion. Decreasing the temperature of the gas mixture reduces heat transfer losses. If the gas mixture has a high percentage of the second exhaust product recirculated (such as about 20-30% of exhaust gas recirculated, or about 25% of the exhaust gas recirculated), this will slow combustion to the point of possible instability unless an accelerant is added, such as the reformate, and specifically for example hydrogen, resulting from adding extra fuel to one or more cylinders 20 (such as the second subset of the plurality of cylinders 20) to stabilize combustion, which will be discussed further below.

The EGR cooler 62 may include a plurality of closed cooling passageways that fluidly couple an inlet 24 volume with an outlet volume. The cooling passageways may be formed from a thermally conductive material, such as aluminum, and may further include a plurality of heat transfer features, such as fins or wires, that may promote heat transfer between the externally flowing atmospheric air or liquid coolant and the internally contained gas mixture.

The EGR system 48 includes a first sensor 64 disposed between the valve 58 and the air intake system 14. Generally, the first sensor 64 may measure an amount of re-combustible exhaust constituents, such as hydrogen, hydro-carbons and/or carbon monoxide, among other constituents. The re-combustible exhaust constituents may also be referred to as reformate. Therefore, the first sensor 64 may measure an amount of reformate in the second exhaust product when the valve 58 is in the second position. For example, the first sensor 64 may measure an amount of hydrogen in the second exhaust product when the valve 58 is in the second position. Furthermore, the first sensor 64 may measure an amount of air and fuel in the second exhaust product when the valve 58 is in the second position. The first sensor 64 may measure the reformate, such as hydrogen, hydro-carbons, etc., the air and/or the fuel, directly or indirectly. The information collected via the first sensor 64 is utilized to determine whether an amount of fuel injected via the fuel injectors 22 should be adjusted in order to stabilize combustion, and thus, improve efficiency of the engine 12. The first sensor 64 may be an air-fuel sensor, a wide range oxygen sensor, a hydrocarbon sensor, or any other suitable sensor to measure the mixture of the second exhaust product. Other optional examples of the first sensor 64 may include a hydrogen gas sensor, a reformate gas sensor, a catalytic sensor, an electrochemical sensor, a metal oxide sensor, a MOSFET sensor, etc.

Generally, the EGR cooler 62 is disposed downstream from the first sensor 64. Downstream being relative to the direction of arrow 66 in FIG. 1. More specifically, in certain configurations, the EGR cooler 62 is disposed between the first sensor 64 and the air intake system 14. Even more specifically, in certain configurations, the EGR cooler 62 is disposed between the first sensor 64 and the EGR mixer 26. Furthermore, in certain configurations, the first sensor 64 is disposed between the EGR cooler 62 and the valve 58.

The EGR cooler 62 is configured to output the second exhaust product at a predetermined temperature. More specifically, the EGR cooler 62 is configured to output the second exhaust product at the predetermined temperature which reduces combustion temperature at the cylinders 20. Even more specifically, the predetermined temperature of the fresh air 34 and the second exhaust product reduces the combustion temperature at the cylinders 20. So if the gas mixture has a high percentage of the second exhaust product recirculated (such as about 20-30% of exhaust gas recirculated, or about 25% of the exhaust gas recirculated), this will slow combustion to the point of possible instability unless an accelerant is added, such as the reformate, and specifically for example hydrogen, resulting from adding extra fuel to one or more cylinders 20 (such as the second subset of the plurality of cylinders 20) to stabilize combustion.

Therefore, extra fuel is added to the second subset of the plurality of cylinders 20 via the respective fuel injector 22 to increase the amount of the reformate, and specifically for example hydrogen, that is routed through the EGR system 48 to stabilize combustion at the cylinders 20. More specifically, extra fuel is added to the second subset of the plurality of cylinders 20 during combustion via the respective fuel injector 22 to increase the amount of reformate, and specifically for example hydrogen, disposed in the second exhaust product to restore combustion stability when the second exhaust product reaches the cylinders 20 after being routed through the EGR system 48. By adding the reformate, such as for example hydrogen as the accelerant, to the second exhaust product, combustion stability is restored. The amount of reformate, such as for example hydrogen to add, via changing the amount of fuel injected, may be a function of a speed of the engine 12 and a load on the engine 12. In certain configurations, the amount of fuel injected into the second subset of the plurality of cylinders 20 may be up to 40% richer than the amount of fuel injected into the first subset of the plurality of cylinders 20. Therefore, the amount of reformate, such as for example hydrogen, in the second exhaust product to stabilize combustion may be about 20% to about 40% more than the first exhaust product. The location of the first sensor 64 provides an accurate measurement of the mixture of the second exhaust product, such as the reformate, which may include hydrogen, the air and/or the fuel, in which the controller 68 may use this information to increase efficiency of the engine 12, and thus, provide optimal engine operation.

A controller 68 may be in electrical communication with the first sensor 64 and the respective fuel injector 22. In certain configurations, the controller 68 may signal the respective fuel injector 22 to adjust the amount of the fuel being introduced into the respective cylinders 20 depending on the amount of reformate, such as for example hydrogen, in the second exhaust product when the valve 58 is in the second position. In other configurations, the controller 68 signals the respective fuel injector 22 to adjust the amount of the fuel being introduced into the respective cylinders 20 depending on the amount of reformate, such as for example hydrogen, air and fuel in the second exhaust product when the valve 58 is in the second position.

Also, the controller 68 may be in electrical communication with the valve 58 to control and/or determine which position the valve 58 is in (the first position or the second position). Therefore, the controller 68 may signal the valve 58 to move to the first position or the second position. Additionally, the controller 68 may monitor the valve 58 to determine which position the valve 58 is in (the first position or the second position).

The controller 68 may be in electrical communication with the first sensor 64 to compile information regarding the amount of reformate in the second exhaust product when the valve 58 is in the second position. Therefore, the controller 68 may signal the respective fuel injector 22 to adjust the amount of the fuel being introduced into the respective cylinders 20 depending on the information collected via the first sensor 64 regarding the amount of reformate detected in the second exhaust product when the valve 58 is in the second position.

The controller 68 may also be in electrical communication with the engine 12 to compile information regarding the speed of the engine 12 and the load on the engine 12. The controller 68 may utilizes this information, in combination with the information from the first sensor 64 to signal the respective fuel injector 22 to adjust the amount of the fuel being introduced into the respective cylinders 20 depending on the information collected via the first sensor 64 regarding the amount of reformate detected in the second exhaust product when the valve 58 is in the second position.

The controller 68 may be in electrical communication with the aftertreatment apparatus 42 to remove various byproducts from the air and fuel mixture of the exhaust product. More specifically, the controller 68 may be in electrical communication with the second sensor 46 to compile information regarding the amount of byproduct (before the exhaust product enters the aftertreatment apparatus 42). Therefore, for example, the amount of fuel injected into the cylinders 20 may be adjusted depending on the information from the second sensor 46.

The controller 68 may be part of an electronic control module that is in communication with various components of the vehicle system 10. The controller 68 includes a processor 70 and a memory 72 on which is recorded instructions for communicating with the valve 58, the fuel injectors 22, the turbocharger 18, the aftertreatment apparatus 42, the first and second sensors 64, 46, the throttle 30, the engine 12, etc. The controller 68 is configured to execute the instructions from the memory 72, via the processor 70. For example, the controller 68 may be a host machine or distributed system, e.g., a computer such as a digital computer or microcomputer, acting as a vehicle system control module, and/or as a proportional-integral-derivative (PID) controller 68 device having the processor 70, and, as the memory 72, tangible, non-transitory computer-readable memory such as read-only memory (ROM) or flash memory. The controller 68 may also have random access memory (RAM), electrically erasable programmable read only memory (EEPROM), a high-speed clock, analog-to-digital (A/D) and/or digital-to-analog (D/A) circuitry, and any required input/output circuitry and associated devices, as well as any required signal conditioning and/or signal buffering circuitry. Therefore, the controller 68 may include all software, hardware, memory 72, algorithms, connections, sensors 64, 46, other sensors, etc., necessary to, collect information, signal, monitor and control the valve 58, the fuel injectors 22, the turbocharger 18, the aftertreatment apparatus 42, the first and second sensors 64, 46, the throttle 30, the engine 12, etc. As such, a control method may be embodied as software or firmware associated with the controller 68. It is to be appreciated that the controller 68 may also include any device capable of analyzing data from various sensors including but not limited to the first and second sensors 64, 46, comparing data, making the necessary decisions required to collect information, signal, monitor and control the valve 58, the fuel injectors 22, the turbocharger 18, the aftertreatment apparatus 42, the first and second sensors 64, 46, the throttle 30, the engine 12, etc. The controller 68 may utilize an algorithm or a model to utilize the information from the first sensor 64, the engine 12, etc., to determine whether the amount of fuel injected into the respective fuel injector 22 should be adjusted to increase the efficiency of the engine 12. The algorithm and/or the model utilized via the controller 68 may be based on the engine 12 speed and the load on the engine 12, as well as the amount of reformate, which may include hydrogen, in the second exhaust product and the temperature of the fresh air 34 and/or the temperature of the second exhaust product to stabilize combustion.

The controller 68, having the processor 70 and tangible, non-transitory memory 72 on which is recorded instructions, and the controller 68 is configured to control the amount of fuel being injected into the plurality of cylinders 20 of the internal combustion engine 12 and actuate the valve 58 to route the second exhaust product in the desired direction. The controller 68 may be configured to actuate the valve 58 in the first position that routes the second exhaust product toward the aftertreatment apparatus 42 (see arrows 74) and bypasses the EGR system 48, and the second position that routes the second exhaust product through the EGR system 48 back to the air intake system 14 (see arrows 76).

Additionally, the controller 68 is configured to signal the fuel injector 22 of each of the plurality of cylinders 20 to inject a predetermined amount of fuel into each of the plurality of cylinders 20 to produce the first exhaust product having a certain amount of fuel and the second exhaust product having extra fuel. As such, the first exhaust product may have less fuel (a leaner mixture) than the second exhaust product (a richer mixture). The first exhaust product is expelled out of the exhaust manifold 40, through the turbocharger 18 toward the aftertreatment apparatus 42. When the valve 58 is in the first position, the first exhaust product and the second exhaust product are directed through the exhaust manifold 40 and directed to the aftertreatment apparatus 42 via the turbine 50 of the turbocharger 18. The turbocharger 18 expels the first exhaust product regardless of which position the valve 58 is in. Therefore, the turbocharger 18 expels the first exhaust product when the valve 58 is in the first position or the second position. The controller 68 may also communicate with the turbocharger 18.

To determine the temperature of the aftertreatment apparatus 42, a sensor, an algorithm and/or time may be utilized to determine when the aftertreatment apparatus 42 is warmed-up. Therefore, the controller 68 may be in communication with the aftertreatment apparatus 42. Alternatively, or in addition to, the controller 68 can utilize an algorithm to determine when the aftertreatment apparatus 42 is warmed-up. It is to be appreciated that any suitable components or methods may be utilized to determine the temperature of the aftertreatment apparatus 42 and/or when the aftertreatment apparatus 42 is adequately warmed-up to contribute to efficiently controlling emissions expelled from the engine 12.

The present disclosure also provides a method of increasing efficiency of the engine 12. The amount of fuel being injected into the plurality of cylinders 20 of the engine 12 is controlled via a respective fuel injector 22. In certain configurations, controlling the amount of fuel being injected into the cylinders 20 includes signaling the respective fuel injector 22, via the controller 68, to adjust the amount of the fuel being introduced into the respective cylinders 20 depending on the compiled information via the controller 68 regarding the measured amount of reformate detected in the second exhaust product expelled through the EGR system 48. The fuel is combusted in the first subset of the plurality of cylinders 20 to produce the first exhaust product. Extra fuel is combusted in the second subset of the plurality of cylinders 20 to produce the second exhaust product having an additional amount of reformate, such as for example hydrogen.

Exhaust gas is expelled from the cylinders 20 once the fuel is combusted. As such, the first exhaust product is expelled out of the first subset of the plurality of cylinders 20 and through the exhaust system 16, and the second exhaust product is expelled out of the second subset of the plurality of cylinders 20 and through the EGR system 48 when the valve 58 is in a predetermined position, such as the second position. Therefore, if it is desirable to recirculate the second exhaust product, the valve 58 is in the second position to direct the second exhaust product through the EGR system.

Additionally, the amount of reformate, such as for example hydrogen, in the second exhaust product is measured via the first sensor 64 when the second exhaust product is directed through the EGR system 48. The first sensor 64 communicates with the controller 68, and the controller 68 determines whether to signal the respective fuel injector 22 to change the amount of fuel being injected. Therefore, the method also includes determining whether to adjust the amount of fuel being injected into the cylinders 20 via the respective fuel injector 22 due to the measured amount of reformate, such as for example hydrogen. In certain configurations, determining whether to adjust the amount of fuel being injected into the cylinders 20 via the respective fuel injector 22 due to the measured amount of reformate, such as for example hydrogen, may include compiling information via the controller 68 regarding the measured amount of reformate in the second exhaust product detected via the first sensor 64.

The second exhaust product may be cooled via the EGR cooler 62 of the EGR system 48 to output the second exhaust product at the predetermined temperature. Also, the fresh air 34 outputted from the air cooler 28 of the air intake system 14 is at the predetermined temperature. The predetermined temperature of the second exhaust product and the fresh air 34 may be different or the same.

The method may further include mixing the fresh air 34 from the air cooler 28 and the second exhaust product via the EGR mixer 26 when the second exhaust product is directed through the EGR system 48 to direct the fresh air 34 and the second exhaust product which includes the predetermined amount of reformate at the predetermined temperature to each of the cylinders 20.

Lowering the combustion temperature at the cylinders 20 reduces heat transfer. If the gas mixture has a high percentage of the second exhaust product recirculated (such as about 20-30% of exhaust gas recirculated, or about 25% of the exhaust gas recirculated), this may slow combustion. The method may also include reducing the combustion temperature at the cylinders 20 due to the predetermined temperature of the fresh air 34 and the second exhaust product directed to the cylinders 20. If combustion is slowed to the point of instability, it is desirable to add the accelerant to restore combustion stability. Therefore, extra fuel may be added to the second subset of the plurality of cylinders 20 via the respective fuel injector 22 to increase the amount of reformate, such as for example hydrogen, that is routed through the EGR system 48 to stabilize combustion at the cylinders 20 due to the high percentage of the second exhaust product recirculated (such as about 20-30% of exhaust gas recirculated, or about 25% of the exhaust gas recirculated) in the gas mixture.

It is to be appreciated that the order or sequence of performing the method is for illustrative purposes and other orders or sequences are within the scope of the present teachings. Also, it is to also be appreciated that the method may include other features not specifically identified in the discussion of the method immediately above.

While the best modes and other configurations for carrying out the disclosure have been described in detail, those familiar with the art to which this disclosure relates will recognize various alternative designs and configurations for practicing the disclosure within the scope of the appended claims. Furthermore, the configurations shown in the drawings or the characteristics of various configurations mentioned in the present description are not necessarily to be understood as configurations independent of each other. Rather, it is possible that each of the characteristics described in one of the examples of a configuration can be combined with one or a plurality of other desired characteristics from other configurations, resulting in other configurations not described in words or by reference to the drawings. Accordingly, such other configurations fall within the framework of the scope of the appended claims.

What is claimed is:

1. A vehicle system comprising:
an engine defining a plurality of cylinders and configured to combust a fuel;
an air intake system disposed upstream from the engine, and each of the cylinders is coupled to the air intake system;
wherein combustion of the fuel occurs within a first subset of the plurality of cylinders which produces a first exhaust product;
wherein combustion of the fuel occurs within a second subset of the plurality of cylinders which produces a second exhaust product;
an exhaust system disposed downstream from the engine, and the exhaust system is in fluid communication with the first subset of the plurality of cylinders;
an exhaust gas recirculation (EGR) system in selective fluid communication with the second subset of the plurality of cylinders and the air intake system to route the second exhaust product from the second subset of the plurality of cylinders to the air intake system;
a valve coupled to the EGR system and the exhaust system, and the valve includes a first position that routes the second exhaust product directly to the exhaust system and bypasses the EGR system, and the valve includes a second position that routes the second exhaust product directly to the EGR system; and
wherein the EGR system includes a first sensor disposed between the valve and the air intake system, and the first sensor measures an amount of reformate in the second exhaust product when the valve is in the second position.

2. The vehicle system as set forth in claim 1:
wherein each of the cylinders include a fuel injector configured to introduce the fuel into the respective cylinders for combustion; and
further including a controller in electrical communication with the first sensor and the respective fuel injector in which the controller signals the respective fuel injector to adjust the amount of the fuel being introduced into the respective cylinders depending on the amount of reformate in the second exhaust product when the valve is in the second position.

3. The vehicle system as set forth in claim 1:
wherein each of the cylinders include a fuel injector configured to introduce the fuel into the respective cylinders for combustion;
wherein the first sensor measures an amount of air and fuel in the second exhaust product when the valve is in the second position; and
further including a controller in electrical communication with the first sensor and the respective fuel injector in which the controller signals the respective fuel injector to adjust the amount of the fuel being introduced into the respective cylinders depending on the amount of reformate, air and fuel in the second exhaust product when the valve is in the second position.

4. The vehicle system as set forth in claim 1 wherein:
each of the cylinders include a fuel injector configured to introduce the fuel into the respective cylinders for combustion; and
extra fuel is added to the second subset of the plurality of cylinders during combustion via the respective fuel injector to increase the amount of reformate disposed in the second exhaust product to restore combustion stability when the second exhaust product reaches the cylinders after being routed through the EGR system.

5. The vehicle system as set forth in claim 1 wherein:
each of the cylinders include a fuel injector configured to introduce the fuel into the respective cylinders for combustion; and
the EGR system includes an EGR cooler disposed between the first sensor and the air intake system, and the EGR cooler is configured to output the second exhaust product at a predetermined temperature which reduces combustion temperature at the cylinders, and wherein extra fuel is added to the second subset of the plurality of cylinders via the respective fuel injector to increase the amount of reformate that is routed through the EGR system to stabilize combustion at the cylinders.

6. The vehicle system as set forth in claim 1:
wherein the air intake system includes an air cooler configured to output fresh air at a predetermined temperature;
wherein the EGR system includes an EGR cooler disposed between the first sensor and the air intake system, and the EGR cooler is configured to output the second exhaust product at a predetermined temperature; and
wherein the predetermined temperature of the fresh air and the second exhaust product reduces a combustion temperature at the cylinders.

7. The vehicle system as set forth in claim 6 wherein the air intake system includes an EGR mixer that is configured to mix the fresh air from the air cooler and the second exhaust product when the valve is in the second position to direct the fresh air and the second exhaust product which includes a predetermined amount of reformate at the predetermined temperature to each of the cylinders.

8. The vehicle system as set forth in claim 7 wherein:
each of the cylinders include a fuel injector configured to introduce the fuel into the respective cylinders for combustion; and
the EGR cooler is disposed between the first sensor and the EGR mixer, and wherein extra fuel is added to the second subset of the plurality of cylinders via the respective fuel injector to increase the amount of reformate that is routed through the EGR system to stabilize combustion at the cylinders.

9. The vehicle system as set forth in claim 1 further including:
a turbocharger in fluid communication with the exhaust system, and wherein the turbocharger expels the first exhaust product, and expels the second exhaust product when the valve is in the first position which bypasses the EGR system;
an aftertreatment apparatus coupled to the turbocharger, and configured to remove byproduct of the exhaust product prior to exiting the exhaust system; and
a second sensor disposed between the turbocharger and the aftertreatment apparatus to measure an amount of the byproduct that enters the aftertreatment apparatus.

10. The vehicle system as set forth in claim 9 further including a controller in electrical communication with the first sensor to compile information regarding the amount of reformate in the second exhaust product when the valve is in the second position, and the controller is in electrical communication with the second sensor to compile information regarding the amount of byproduct.

11. The vehicle system as set forth in claim 1:
wherein each of the cylinders include a fuel injector configured to introduce the fuel into the respective cylinders for combustion;
wherein the air intake system is disposed upstream from the engine, and the air intake system includes an air cooler configured to output fresh air at a predetermined temperature;
wherein the air intake system includes an EGR mixer disposed upstream from the engine, and the EGR mixer is configured to mix the fresh air from the air cooler and the second exhaust product when the valve is in the second position to output the fresh air and the second exhaust product which includes a predetermined amount of reformate to each of the cylinders;
wherein the EGR system includes an EGR cooler disposed between the first sensor and the EGR mixer, and the EGR cooler is configured to output the second exhaust product at a predetermined temperature;
wherein the first sensor is disposed between the EGR cooler and the valve;
wherein the predetermined temperature of the fresh air and the second exhaust product reduces a combustion temperature at the cylinders;
wherein extra fuel is added to the second subset of the plurality of cylinders via the respective fuel injector to increase the amount of reformate that is routed through the EGR system to stabilize combustion at the cylinders;
further including a turbocharger in fluid communication with the exhaust system, and wherein the turbocharger expels the first exhaust product, and expels the second exhaust product when the valve is in the first position which bypasses the EGR system;
further including an aftertreatment apparatus coupled to the turbocharger, and configured to remove byproduct of the exhaust product prior to exiting the exhaust system;
further including a second sensor disposed between the turbocharger and the aftertreatment apparatus to measure an amount of the byproduct that enters the aftertreatment apparatus;
further including a controller in electrical communication with the first sensor to compile information regarding the amount of reformate in the second exhaust product when the valve is in the second position, and the controller is in electrical communication with the second sensor to compile information regarding the amount of byproduct before the exhaust product enters the aftertreatment apparatus; and
wherein the controller is in electrical communication with the respective fuel injector in which the controller signals the respective fuel injector to adjust the amount of the fuel being introduced into the respective cylinders depending on the information collected via the first sensor regarding the amount of reformate detected in the second exhaust product when the valve is in the second position.

12. A method of increasing efficiency of an engine, the method comprising:
controlling an amount of fuel being injected into a plurality of cylinders of the engine via a respective fuel injector;
combusting the fuel in a first subset of the plurality of cylinders to produce a first exhaust product;
combusting extra fuel in a second subset of the plurality of cylinders to produce a second exhaust product having an additional amount of reformate;
expelling the first exhaust product out of the first subset of the plurality of cylinders and through an exhaust system;
expelling the second exhaust product out of the second subset of the plurality of cylinders and through an exhaust gas recirculation (EGR) system when a valve is in a predetermined position;
measuring the amount of reformate in the second exhaust product via a first sensor when the second exhaust product is directed through the EGR system; and
determining whether to adjust the amount of fuel being injected into the cylinders via the respective fuel injector due to the measured amount of reformate.

13. The method as set forth in claim 12 further comprising cooling the second exhaust product via an EGR cooler of the EGR system to output the second exhaust product at a predetermined temperature, and wherein the EGR cooler is disposed downstream from the first sensor.

14. The method as set forth in claim 13 further comprising outputting fresh air from an air cooler of an air intake system at a predetermined temperature.

15. The method as set forth in claim 14 further comprising mixing the fresh air from the air cooler and the second exhaust product via an EGR mixer when the second exhaust product is directed through the EGR system to direct the fresh air and the second exhaust product which includes a predetermined amount of reformate at the predetermined temperature to each of the cylinders.

16. The method as set forth in claim 15 further comprising reducing a combustion temperature at the cylinders due to the predetermined temperature of the fresh air and the second exhaust product directed to the cylinders.

17. The method as set forth in claim 16 further comprising adding extra fuel to the second subset of the plurality of cylinders via the respective fuel injector to increase the amount of reformate that is routed through the EGR system to stabilize combustion at the cylinders.

18. The method as set forth in claim 12 wherein:
determining whether to adjust the amount of fuel being injected into the cylinders via the respective fuel injector due to the measured amount of reformate includes compiling information via a controller regarding the measured amount of reformate in the second exhaust product detected via the first sensor; and
controlling the amount of fuel being injected into the cylinders includes signaling the respective fuel injector, via the controller, to adjust the amount of the fuel being introduced into the respective cylinders depending on the compiled information via the controller regarding the measured amount of reformate detected in the second exhaust product expelled through the EGR system.

19. The method as set forth in claim 12:
further comprising cooling the second exhaust product via an EGR cooler of the EGR system to output the second exhaust product at a predetermined temperature, and wherein the EGR cooler is disposed downstream from the first sensor;
further comprising outputting fresh air from an air cooler of an air intake system at a predetermined temperature;
further comprising reducing a combustion temperature at the cylinders due to the predetermined temperature of the fresh air and the second exhaust product directed to the cylinders;
further comprising adding extra fuel to the second subset of the plurality of cylinders via the respective fuel injector to increase the amount of reformate that is routed through the EGR system to stabilize combustion at the cylinders;
wherein determining whether to adjust the amount of fuel being injected into the cylinders via the respective fuel injector due to the measured amount of reformate includes compiling information via a controller regarding the measured amount of reformate in the second exhaust product detected via the first sensor; and
wherein controlling the amount of fuel being injected into the cylinders includes signaling the respective fuel injector, via the controller, to adjust the amount of the fuel being introduced into the respective cylinders depending on the compiled information via the controller regarding the measured amount of reformate detected in the second exhaust product expelled through the EGR system.
